(19) United States
(12) Patent Application Publication
(10) Pub. No.: US 2009/0188164 A1
(43) Pub. Date: Jul. 30, 2009

(54) METHOD AND SYSTEM FOR HYDROGEN SULFIDE REMOVAL

(75) Inventors: CUNPING HUANG, Cocoa, FL (US); FRANKLYN SMITH, Friendswood, TX (US); CLOVIS A. LINKOUS, Merritt Island, FL (US); KARTHIKEYAN RAMASAMY, Orlando, FL (US); ALI T. RAISSI, Melbourne, FL (US); NAZIM MURADOV, Melbourne, FL (US)

Correspondence Address: PATENTS ON DEMAND - UCF, 4581 WESTON ROAD, SUITE 345, WESTON, FL, 33331, US

(73) Assignee: UNIVERSITY OF CENTRAL FLORIDA RESEARCH FOUNDATION, INC., ORLANDO, FL (US)

(21) Appl. No.: 12/359,858

(22) Filed: Jan. 26, 2009

Related U.S. Application Data
(60) Provisional application No. 61/023,755, filed on Jan. 25, 2008.

(51) Int. Cl. C10L 3/10; B01J 8/00

(52) U.S. Cl. 48/127.7; 48/127.9

(57) ABSTRACT

A method and system for hydrogen sulfide removal from a sour gas mixture including hydrogen sulfide includes providing an aqueous solution comprising a transition metal oxide, sulfide or carbonate compound, wherein a transition metal of the transition metal oxide is at a first valence and has at least one reduction state from the first valence. The sour gas mixture is reacted with the transition metal compound and the aqueous solution in a reactor, wherein sulfide from the hydrogen sulfide is oxidized to form elemental sulfur and the transition metal is reduced to form a reduced state transition metal compound. An electrochemical redox reaction is performed including the reduced state transition metal compound to regenerate the transition metal compound in an electrolyzer comprising an anode, a cathode, and an electrolyte membrane between the anode and cathode, wherein an oxygen including gas is added to the cathode during the electrochemical redox reaction. The transition metal compound that is regenerated in the electrochemical redox reaction is then returned to the reactor for the reacting.

### CROSS REFERENCE TO RELATED APPLICATIONS

This application claims the benefit of Provisional Application Ser. No. 61/023,755 entitled “METHOD AND SYSTEM FOR HYDROGEN SULFIDE REMOVAL”, filed Jan. 25, 2008, which is herein incorporated by reference in its entirety.

### FIELD OF THE INVENTION

Embodiments of the invention are related to hydrogen sulfide (H2S) removal.

### BACKGROUND

Removal of hydrogen sulfide has become increasingly important because of the increased need for natural gas production. Approximately one-third of U.S. natural gas resources can be considered as low or sub-quality gas not suited for pipeline shipment with impurity concentrations in natural gas varying from traces to 90% by volume. In natural gas processing hydrogen sulfide is viewed as a pollutant because it corrodes pipelines and deactivates metal-based catalysts used in steam methane reformation (SMR). There are a number of known hydrogen sulfide removal processes practiced commercially or in bench scale demonstrations. Based on the hydrogen sulfide reactions involved, these technologies can generally be separated into three categories:

Decomposition: H2S=½S2+H2 ΔH° 298K=79.9 kJ/mol

Reformation: 2H2S+CH4=CS2+4H2 ΔH° 298K=232.4 kJ/mol

Partial oxidation: H2S+½O2=S+H2O ΔH° 298K=−265.2 kJ/mol

Unfortunately, commercial systems based on any of the hydrogen sulfide removal processes shown above generally include one or more significant shortcomings, such as low efficiency and several technical issues, such as chelate loss, solution loss, slow oxidation rate. In addition, the reactors are generally complex designs that involve high capital and operation costs. What is needed is a new hydrogen sulfide removal process and related system that provides improved efficiency, and a relatively low capital cost system that also provides reliable and relatively low cost operation.

### SUMMARY

This Summary is provided to comply with 37 C.F.R. §1.73, presenting a summary of the invention briefly indicating the nature and substance of the invention. It is submitted with the understanding that it will not be used to interpret or limit the scope or meaning of the claims.

Electrochemical redox methods and systems for implementing for continuous removal of hydrogen sulfide and other sulfur species from sour gas mixtures are described herein. The coulombic efficiency of such methods generally exceeds 90%.

In one embodiment, a method for hydrogen sulfide removal from a sour gas mixture comprising hydrogen sulfide comprises providing an aqueous solution comprising a transition metal oxide, sulfide or carbonate compound, wherein a transition metal of the transition metal oxide is at a first valence and has at least one reduction state from the first valence. The sour gas mixture is reacted with the transition metal compound and the aqueous solution in a reactor, wherein sulfide from the hydrogen sulfide is oxidized to form elemental sulfur and the transition metal is reduced to form a reduced state transition metal compound. An electrochemical redox reaction is performed including the reduced state transition metal compound to regenerate the transition metal compound in an electrolyzer comprising an anode, a cathode, and an electrolyte membrane between the anode and cathode, wherein an oxygen comprising gas is added to the cathode during the electrochemical redox reaction. The transition metal compound that is regenerated in the electrochemical redox reaction is then returned to the reactor for the reacting.

The overall reaction in this embodiment is:

H2S(g)+½O2=H2O(l)+S(s); applied ΔE=generally <0.5 V, such as 0.20˜0.50 V

A system for hydrogen sulfide removal from a sour gas mixture comprising hydrogen sulfide is also disclosed. The system includes a reactor having an inlet for receiving the sour gas mixture and an aqueous solution comprising a transition metal oxide, sulfide or carbonate compound, wherein a transition metal of the transition metal oxide is at a first valence and has at least one reduction state from the first valence. The reactor is operable for reacting the sour gas mixture with the transition metal compound and the aqueous solution, wherein sulfide from the hydrogen sulfide is oxidized to form an elemental sulfur precipitate, the transition metal is reduced to form a reduced state transition metal compound, and an acid is formed. A sulfur capture device is coupled to an output of the reactor operable to capture the elemental sulfur precipitate and provide a sweet gas output. An electrolyzer is coupled to receive the reduced state transition metal compound and the acid. The e3lectrolyzer comprises an anode, a cathode, and an electrolyte membrane between the anode and cathode for performing an electrochemical redox reaction including the reduced state transition metal compound to regenerate the transition metal compound, wherein the electrolyzer includes an inlet for receiving an oxygen comprising gas at the cathode during the electrochemical redox reaction. A connector is provided for coupling an output of the electrolyzer to an input of the reactor, wherein the transition metal compound that is regenerated in the electrochemical redox reaction is returned to the reactor.

### BRIEF DESCRIPTION OF THE DRAWINGS

FIG. 1 is a schematic diagram showing an exemplary system operable for continuous removal of hydrogen sulfide and sulfur from sour gas, wherein the system provides production of gaseous hydrogen.

FIG. 2 is a schematic diagram showing an exemplary system operable for hydrogen sulfide removal by the partial oxidation of hydrogen sulfide, wherein the system provides production of elemental sulfur and water.

FIG. 3 shows an exemplary electrolyzer system that was used for the electro-oxidation of aqueous FeSO₄ described in the Examples section.

FIG. 4 shows data from electrolysis of an acidified FeSO₄ solution using a single and a double-sided MEA showing that oxidation of ferrous to ferric ions is not affected by lack of Pt catalyst at the anode, and that only about half the usual amount of Pt metal is needed for the electrolysis.

FIG. 5 shows hydrogen production by electrolysis of an acidified FeSO₄ solution under a first set of conditions.

FIG. 6 shows hydrogen production by electrolysis of an acidified FeSO₄ solution under a second set of conditions.

FIG. 7 shows hydrogen evolution rate as a function of FeSO₄ concentration under yet another set of conditions.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Embodiments of the invention provide methods and systems for removing hydrogen sulfide from a sour gas mixture. As used herein, a “sour gas mixture” refers to a hydrogen sulfide comprising gas mixture, such as hydrogen sulfide mixed with carbon dioxide, carbon monoxide, hydrogen, nitrogen, a hydrocarbon (e.g. methane) or hydrocarbon mixture (e.g. natural gas). Sour gas mixtures can be obtained from natural gas, landfill gas, gas from light hydrocarbon fuel reformation, and other sources. Embodiments of the method comprise providing an aqueous solution comprising a transition metal oxide, sulfide or carbonate compound. The transition metal is at a first valence and has at least one reduction state from the first valence. The gas mixture is reacted with the transition metal compound in a reactor, wherein sulfide from the hydrogen sulfide is oxidized to form an elemental sulfur precipitate, the transition metal is reduced to form a reduced state transition metal compound, and an acid is formed. The sulfur generally precipitates as a fine powder that can be filtered out of the scrubber solution so that the sulfur precipitate can be removed. electrochemical redox reaction is then performed in an electrolyzer, wherein electrochemical oxidation of the reduced state transition metal occurs to recover the transition metal compound. The transition metal compound is then returned to the reactor for the reacting step.

The electrochemical redox reaction can utilize a proton conducting membrane, such as a membrane electrode assembly (MEA). Various transition metals may be used, since ions of the transition elements generally have multiple stable oxidation states, because they can lose d electrons without a high energetic penalty. Fe is one of the transition metals. Iron, cobalt and nickel show similar properties as compared to iron. Regarding chemical properties of iron, as known in the art, iron shows variable valance. Since Fe has 2 electrons in its N-shell, it gives off electrons easily. Fe (II) (ferrous) has valence=2⁺. Fe is able to show 3⁺ valence by emitting one electron from the M-shell. Fe (III) (ferric) has valence=3⁺.

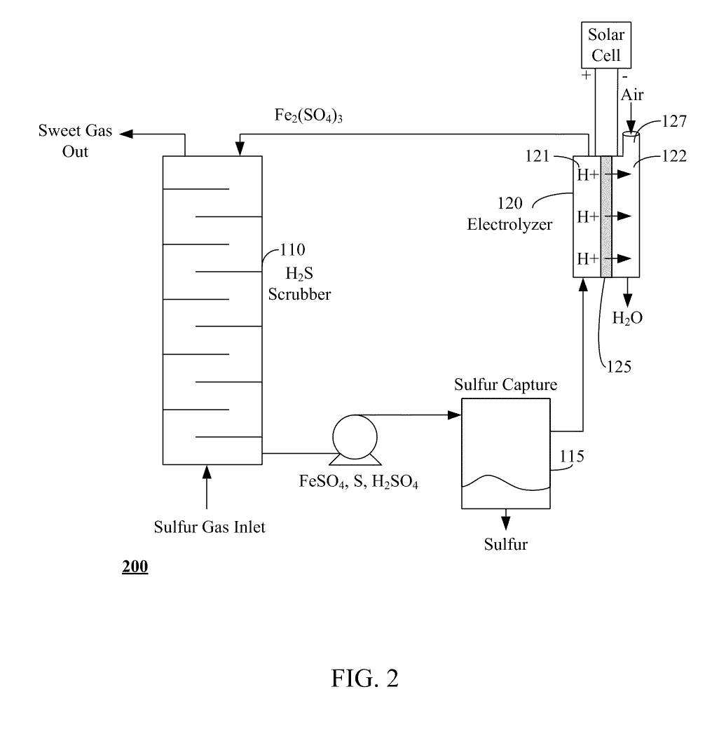

In one particular embodiment the transition metal compound comprises ferric sulfate and the acid comprises sulfuric acid. The electrochemical redox reaction can be used to reduce protons from the acid into hydrogen gas. In another embodiment of the invention described relative to FIG. 2 below, oxygen gas is added to the cathode, wherein the oxygen is reduced and reacts with protons from the acid to form water.

Two exemplary method embodiments are described below which both embody the transition metal compound as ferric sulfate and the acid as sulfuric acid. However, as noted above, other transition metal compounds and other acids may be used.

In a first method embodiment, the overall reaction shown below decomposes hydrogen sulfide to produce elemental sulfur and hydrogen. The process can be practiced as a closed-loop process, where the ferric sulfate Fe₂(SO₄)₃ is regenerated.

Fe₂(SO₄)₃(aq)+H2S(g)→2FeSO₄(aq)+H₂SO₄(aq)+S(s) (Chemical absorption)

2FeSO₄(aq)+H₂SO₄(aq)→Fe₂(SO₄)₃(aq)+H₂(g) (ΔE=0.80˜1.15 V)

H₂S(g))→H₂(g)+S(s); ΔE=0.80˜1.15 V (Overall reaction)

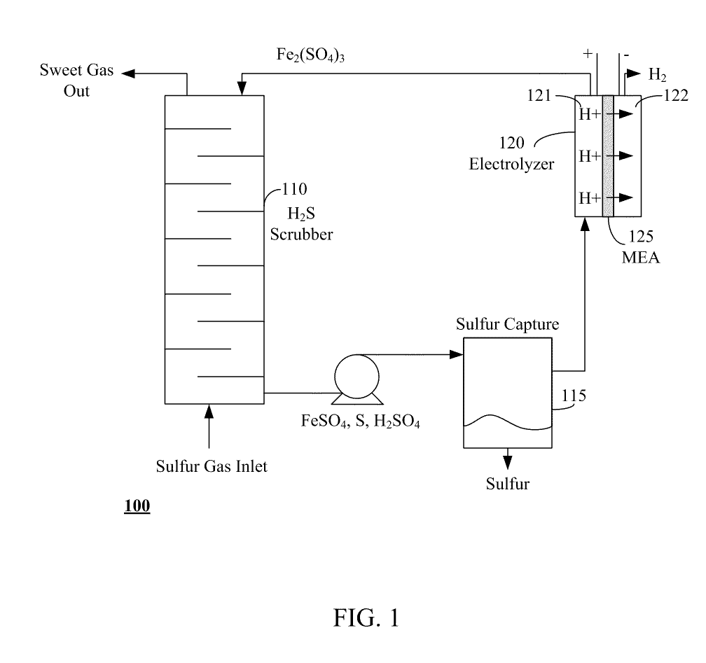

FIG. 1 is a schematic diagram showing an exemplary system 100 operable for continuous removal of hydrogen sulfide and sulfur from sour gas, which also provides production of gaseous hydrogen. A gaseous mixture containing hydrogen sulfide enters into a scrubbing unit 110 shown as a H₂S scrubber which includes an absorption column. H2S when dissolved in the aqueous medium is ionized to H⁺ and S²⁻. In the scrubbing unit 110, the S2⁻ is oxidized by polyvalent metal ions such as those of iron, which can exist in both ferric (Fe³⁺) and ferrous (Fe²⁺) state to produce elemental sulfur. Elemental sulfur generally has commercial value. Ferric sulfate, Fe₂(SO₄)₃ is reduced into ferrous sulfate, FeSO₄. The hydrogen ions from H₂S oxidation and excess sulfate ions from ferric sulfate reduction form aqueous sulfuric acid, H₂SO₄(aq).

Elemental sulfur is then removed from the system in a sulfur capture vessel 115, and the remaining ferrous sulfate solution is fed to an electrolyzer 120 comprising anode 121, cathode 122, and an electrolyte membrane 125, such as a membrane electrode assembly (MEA). In the electrolyzer 120, ferrous sulfate is oxidized back to ferric sulfate. Accompanying the ferrous to ferric electro-oxidation process, hydrogen ions (protons) from sulfuric acid traverse the electrolyte membrane 125 and are reduced to hydrogen gas at the cathode 122 of the electrolyzer 120. The electrolyte membrane 125 facilitates proton transfer and catalyzes the formation of molecular hydrogen. The regenerated ferric sulfate solution is then fed back to the absorption column of scrubber 110 for scrubbing hydrogen sulfide, forming a closed cycle with the net reaction of hydrogen sulfide decomposition into elemental sulfur and hydrogen gas. System 100 may be operated at ambient temperature and with easy start up and shut down procedures. The sweet gas output by system 100 provides low H2S concentration, such as generally <2 ppm.

This first embodiment generally uses an electrolyzer potential of 0.80 to 1.15 volts in order for the electrochemical process to regenerate the scrubber solution at a rate sufficient to match the sulfide flow rate into the scrubber 110. The required electrical input power for the electrolytic unit may be provided from a number of energy sources including grid electricity, or from renewable energy sources, such as solar photovoltaic cells.

FIG. 2 is a schematic diagram showing an exemplary system 200 operable for partial oxidation of hydrogen sulfide, which produces elemental sulfur and water products. System 200 provides continuous removal of hydrogen sulfide and sulfur species from sour gas using an oxygen source, such as air, fed via inlet 127 to the cathode 122 of the electrolyzer 120. In this case, hydrogen sulfide absorption occurs in the same manner as described above relative to operation of system 100. The difference between the respective processes is that for the process performed by system 200, air or other oxygen comprising gas is fed to the inlet of the cathode 122 of the electrolyzer 120. The oxygen (O₂) provided reacts with electrons provided by an external power source shown as a solar cell 135 and protons passing through the electrolyte membrane 125 to form water. The reactions for this embodiment are as follows:

Fe₂(SO₄)₃(aq)+H₂S(g)→2FeSO₄(aq)+H₂SO₄(aq)+S(s) (Chemical absorption)

2FeSO₄(aq)+H₂SO₄(aq)+½O₂(g))→Fe₂(SO₄)₃(aq)+H₂O(l) (ΔE<0.50 V)

H₂S(g)+½O₂(g)→H₂O(l)+S(s) ΔE=0.20˜0.50 V (Overall reaction)

Like system 100, system 200 may be operated at ambient temperatures and with easy start up and shut down procedures. The sweet gas output by system 200 provides low H2S concentrations, such as generally <2 ppm. In contrast to system 100 which produces hydrogen gas at the cathode, water is generated by system 200 which is energetically a more favorable reaction. As a result, the electrical energy requirement to regenerate the scrubber solution is significantly less than that of system 100, significantly reducing the overall operating costs of system 200. Moreover, the use of oxygen depolarization of the cathode by system 200 leads to a more compact system.

A prototype system analogous to system 100 has been constructed and continuously operated for more than 300 hours. Due to its low cost and high energy efficiency, embodiments of the invention are expected to find commercial use in many applications, including those for hydrogen generation at fueling stations. In this particular application, removal of sulfur (in the form of hydrogen sulfide) from pre-reformed diesel fuel is needed for generating a sulfur-free into a steam reformation process for production of hydrogen-on demand and at vehicular fueling stations.

### EXAMPLES

The Examples provided below show particular embodiments of the present invention. Embodiments of the invention are in now way limited by these Examples.

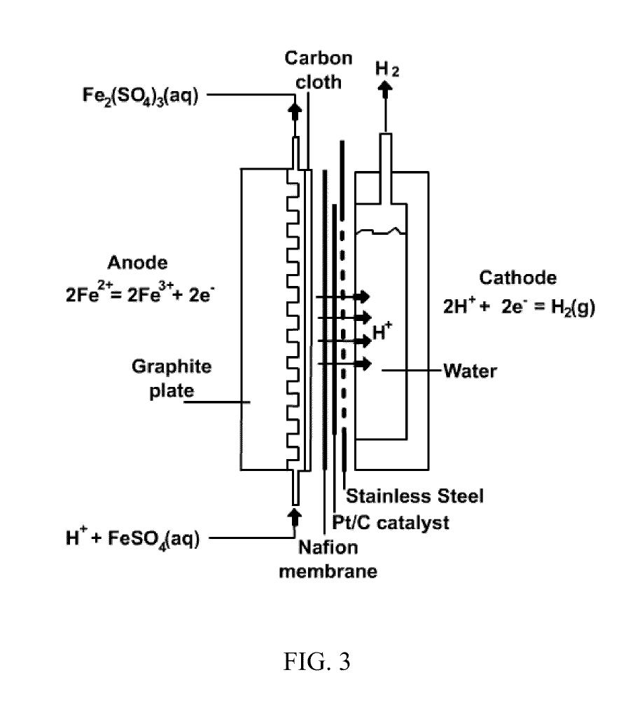

FIG. 3 shows an exemplary electrolyzer system 300 that was used for the electro-oxidation of aqueous FeSO₄ described in the Examples. System 300 includes a modified proton exchange membrane (PEM) fuel cell as shown in FIG. 3. Platinum catalyst was spray-deposited onto the cathode side of a NAFION® film to form a MEA. The cathode section consisted of a stainless steel plate used as current collector in contact with water for hydrogen evolution. This configuration eliminated the need for a carrier gas to sweep hydrogen from the cathode side of the electrolyzer.

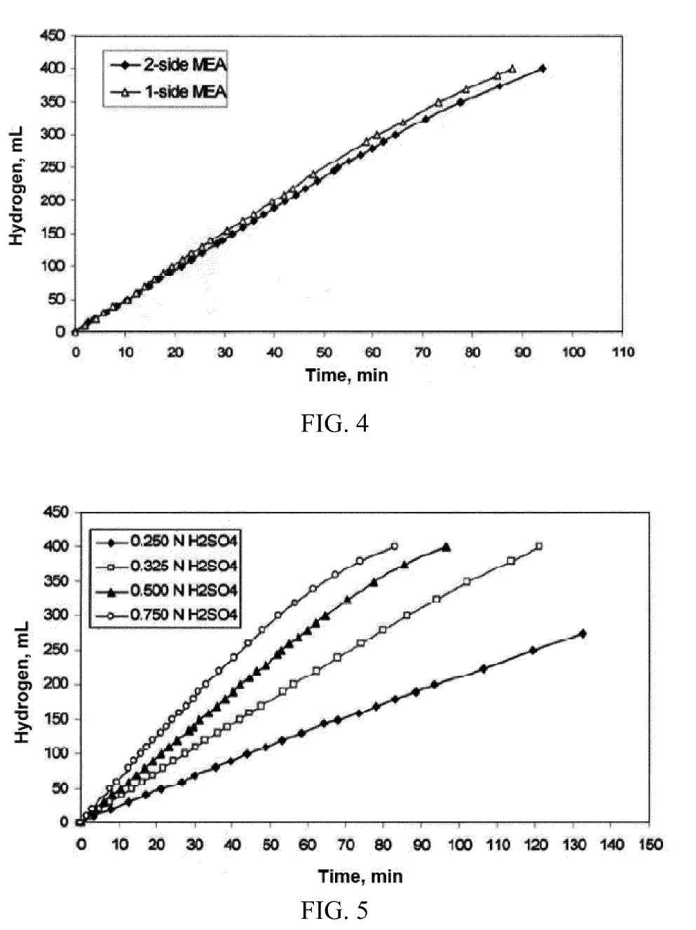

It is noted that no Pt catalyst was found to be needed for the oxidation of ferrous ions in the anodic section of the electrolyzer 300. FIG. 4 shows data from electrolysis of acidified FeSO₄ solution using a single and a double-sided MEA (Pt loading: 1.8 mg/cm², current density: 30-50 mA/cm², electrolyte: 0.5 N H₂SO₄+0.18 M FeSO₄, E=0.95 V). The data obtained shows that oxidation of ferrous to ferric ions is not affected by lack of Pt catalyst at the anode, indicating that only about half the usual amount of Pt metal is needed for the electrolysis. A plain carbon cloth can be used at the anode to allow distribution of both current and electrolyte.

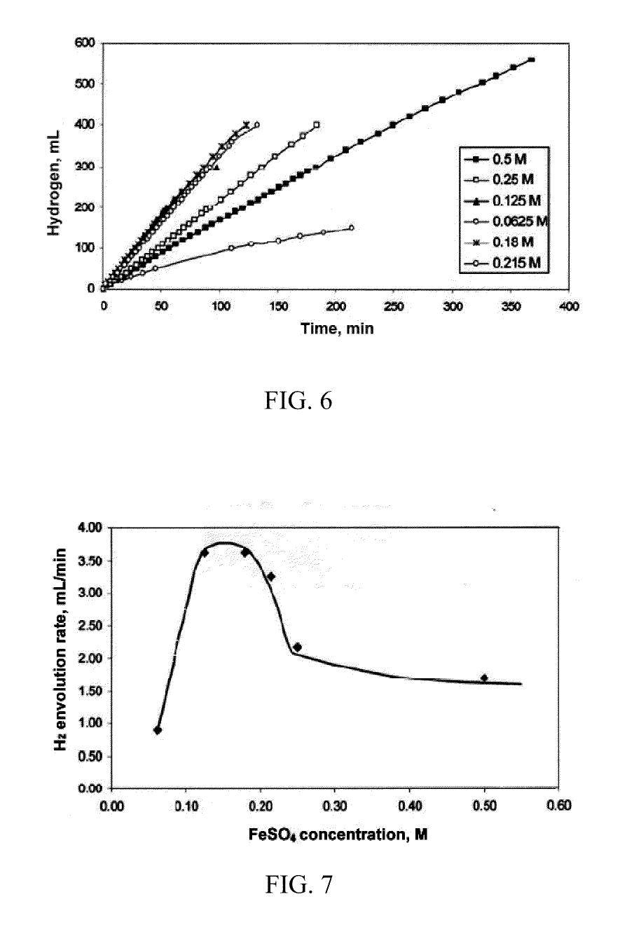

FIG. 5 shows hydrogen production by electrolysis of acidified FeSO₄ solution (single-sided MEA, Pt loading: 1.8 mg/cm², 0.18 M FeSO₄, E=0.95 V). FIG. 6 shows hydrogen production by electrolysis of acidified FeSO₄ solution (single-sided MEA, Pt loading: 1.8 mg/cm², 0.325 N H₂SO₄, E=0.95 V). FIGS. 5 and 6 show that H₂SO₄ and FeSO₄ concentrations both have significant effects on the hydrogen production rate via electrolytic process.

FIG. 7 shows hydrogen evolution rate as a function of FeSO₄ concentration (single-sided MEA, Pt loading: 1.8 mg/cm², 0.325 N H₂SO₄, average pulse voltage 0.95 V). While hydrogen evolution increases linearly with increased H₂SO₄ concentration (not shown here), there was found to exist an optimal concentration of FeSO₄ (0.20 M) that corresponds to the maximum hydrogen production rate as shown in FIG. 7.

### CONCLUSIONS FROM THE EXAMPLE DATA

It has been shown that the electrolysis of acidified FeSO₄ aqueous solution is highly efficient with a columbic efficiency approaching 100% at applied voltage of 1.0 V or lower. The effect of reaction conditions, such as pH, FeSO₄ concentration, and temperature were investigated. It has been shown that the electrolysis process can be conducted with a Pt-free anode capable of oxidizing ferrous to ferric ions, thereby, reducing the cost of the electrolytic system.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and/or the claims, such terms are intended to be inclusive in a manner similar to the term “comprising.”

We claim:

1. A method for hydrogen sulfide removal from a sour gas mixture comprising hydrogen sulfide, comprising:
providing an aqueous solution comprising a transition metal oxide, sulfide or carbonate compound, a transition metal of said transition metal oxide being at a first valence and having at least one reduction state from said first valence;
reacting said sour gas mixture with said transition metal compound and said aqueous solution in a reactor, wherein sulfide from said hydrogen sulfide is oxidized to form elemental sulfur and said transition metal is reduced to form a reduced state transition metal compound;
performing an electrochemical redox reaction including said reduced state transition metal compound to regenerate said transition metal compound in an electrolyzer comprising an anode, a cathode, and an electrolyte membrane between said anode and said cathode, wherein an oxygen comprising gas is added to said cathode during said electrochemical redox reaction, and
returning said transition metal compound that is regenerated in said electrochemical redox reaction to said reactor for said reacting.

2. The method of claim 1, wherein said sour gas mixture comprises at least one hydrocarbon.

3. The method of claim 2, wherein said sour gas mixture comprises natural gas, and a sweet gas output comprising said natural gas has concentration of said hydrogen sulfide that is <2 ppm.

4. The method of claim 1, wherein said elemental sulfur comprises an elemental sulfur precipitate, further comprising the step of removing said elemental sulfur precipitate.

5. The method of claim 1, wherein said electrochemical redox reaction is run at an electrolytic voltage of ≦0.5 V.

6. The method of claim 1, wherein said transition metal compound comprises ferric sulfate and a product of said reacting comprises sulfuric acid.

7. The method of claim 1, wherein said oxygen comprising gas comprises air.

8. A system for hydrogen sulfide removal from a sour gas mixture comprising hydrogen sulfide, comprising:
a reactor having an inlet for receiving said sour gas mixture and an aqueous solution comprising a transition metal oxide, sulfide or carbonate compound, a transition metal of said transition metal oxide being at a first valence and having at least one reduction state from said first valence, said reactor for reacting said sour gas mixture with said transition metal compound and said aqueous solution, wherein sulfide from said hydrogen sulfide is oxidized to form an elemental sulfur precipitate, said transition metal is reduced to form a reduced state transition metal compound, and an acid is formed;
a sulfur capture device coupled to an output of said reactor operable to capture said elemental sulfur precipitate and provide a sweet gas output;
an electrolyzer coupled to receive said reduced state transition metal compound and said acid comprising an anode, a cathode, and an electrolyte membrane between said anode and said cathode for performing an electrochemical redox reaction including said reduced state transition metal compound to regenerate said transition metal compound, wherein said electrolyzer includes an inlet for receiving an oxygen comprising gas at said cathode during said electrochemical redox reaction;
a connector for coupling an output of said electrolyzer to an input of said reactor, wherein said transition metal compound that is regenerated in said electrochemical redox reaction is returned to said reactor by said connector for said reacting.

9. The system of claim 8, further comprising at least one solar cell, wherein power for operation of said electrolyzer is provided at least in part by said solar cell.

10. The system of claim 8, wherein said electrolyte membrane comprises a membrane electrode assembly (MEA).

11. The system of claim 8, wherein said sour gas mixture comprises natural gas, and said sweet gas output comprising said natural gas has concentration of said hydrogen sulfide that is <2 ppm.
